(19) United States
(12) Patent Application Publication
(10) Pub. No.: US 2009/0304019 A1
(43) Pub. Date: Dec. 10, 2009

(54) METHOD AND DEVICE FOR REDUCING MULTICAST TRAFFICE IN A UPNP NETWORK

(75) Inventor: Cathy Chan, Burlington, MA (US)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/397,022

(22) Filed: Mar. 3, 2009

Related U.S. Application Data
(60) Provisional application No. 61/033,292, filed on Mar. 3, 2008.

(51) Int. Cl. H04J 3/26

(52) U.S. Cl. 370/432

(57) ABSTRACT

Methods and devices for facilitating communications over a Universal Plug and Play (UPnP) network are disclosed. These methods and devices reduce network traffic while maintaining maximum freshness of the UPnP controlled device status. These and other features of the present invention are accomplished by introducing an intermediary proxy device to moderate multicast messages that are transmitted over the network. The proxy device receives unicast messages from a UPnP controlled device and transmits multicast information on behalf of the UPnP controlled device at a lower rate. In addition, the proxy device can detect unexpected unavailability of the UPnP controlled device and promptly alert other control points on the UPnP network.

### RELATED APPLICATIONS

This application claims priority under 35 U.S.C. § 119(e) from U.S. Provisional Application Ser. No. 61/033,292, filed Mar. 3, 2008, incorporated herein by reference in its entirety.

### FIELD OF INVENTION

This invention relates to Universal Plug and Play networks. In particular, the present invention relates to methods and devices for facilitating communications in such networks.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Universal Plug and Play (UPnP) technology defines an architecture for pervasive peer-to-peer network connectivity of intelligent appliances, wireless devices, and PCs of all form factors. It is designed to bring easy-to-use, flexible, standards-based connectivity to ad-hoc or unmanaged networks whether in the home, in a small business, public spaces, or attached to the Internet. UPnP technology provides a distributed, open networking architecture that leverages TCP/IP, UDP, HTTP, XML and other Web technologies to enable seamless proximity networking in addition to control and data transfer among networked devices.

The UPnP Device Architecture (UDA) is designed to support zero-configuration, “invisible” networking, and automatic discovery for a breadth of device categories from a wide range of vendors. Under the UDA protocols, a device can dynamically join a network, obtain an IP address, convey its capabilities, and learn about the presence and capabilities of other devices without manual intervention or special set-up services. In addition, a device can leave a network smoothly and automatically without leaving any unwanted states behind.

These and other beneficial feature of the UDA, coupled with decreasing cost of electronic devices, have contributed to the popularity of UPnP networked devices. However, an increase in the number of devices on a UPnP network is inevitably accompanied by an increased network traffic caused by the exchange of myriad messages between the various networked devices. While these messages are necessary to maintain up-to-date status information regarding the network and connected devices, they may create unnecessary delays, lead to increased power consumption, and reduce the lifespan of various components and devices.

### SUMMARY OF THE INVENTION

It is goal of the various embodiments of the present invention to provide methods and devices to facilitate communications over a UPnP network by reducing network traffic while maintaining fresh status information regarding the various devices on the network. In one embodiment, a method for transmitting messages over a network is disclosed. The method comprises receiving one or more unicast messages from a controlled device at a proxy device, and transmitting one or more multicast messages from said proxy device over the network, wherein said multicast messages are transmitted at a lower rate than said unicast messages. Furthermore, the multicast messages may comprise expiration times that are larger than expiration times associated with said unicast messages. The unicast messages may comprise information associated with said controlled device. This information may comprise at least one of an event lifetime and an announcement lifetime value. The multicast messages may also comprise information associated with said proxy device.

In another embodiment, said multicast messages may be transmitted in response to receiving one or more unicast messages at predefined intervals. Furthermore, said proxy device may transmit one or more multicast exit messages upon failure to receive said unicast messages. In another embodiment, said controlled device multicasts one or more exit messages. The proxy device may release resources associated with said controlled device in response to said exit messages. In another embodiment, said controlled device receives one or more acknowledgment messages from said proxy device in response to said unicast messages. In another embodiment, the controlled device transmits one or more multicast alive messages upon failure to receive an acknowledgement message.

In yet another embodiment, said proxy device comprises a control point on said network. In another embodiment, said controlled device implements an OptimizedDiscovery service. In yet another embodiment, said proxy device subscribes to said OptimizedDiscovery service.

Another aspect of the present invention relates to a device comprising a receiver configured to receive one or more unicast messages from a controlled device at a proxy device, and a transmitter configured to transmit one or more multicast messages from said proxy device over the network, wherein said multicast messages are transmitted at a lower rate than said unicast messages.

In another embodiment, a computer program product embodied on a computer-readable medium is disclosed. The program product comprises a computer code for receiving one or more unicast messages from a controlled device at a proxy device, and a computer code for transmitting one or more multicast messages from said proxy device over a network, wherein said multicast messages are transmitted at a lower rate than said unicast messages.

In another embodiment, an apparatus is disclosed, comprising, a processor, and a memory unit communicatively connected to the processor and including computer code for receiving one or more unicast messages from a controlled device at a proxy device and a computer code for transmitting one or more multicast messages from said proxy device over a network, wherein said multicast messages are transmitted at a lower rate than said unicast messages. Another embodiment relates to a device configured to implement a special delivery service, comprising a transmitter configured to transmits one or more multicast messages from a controlled device, and a receiver configured to receive one or more messages from a proxy device in response to said multicast messages, wherein said transmitter is further configured to transmit one or more unicast message to said proxy device in accordance with a special delivery service of said controlled device.

These and other advantages and features of various embodiments of the present invention, together with the organization and manner of operation thereof, will become apparent from the following detailed description when taken in conjunction with the accompanying drawings.

### BRIEF DESCRIPTION OF THE DRAWINGS

Embodiments of the invention are described by referring to the attached drawings, in which:

FIG. 1 illustrates a diagram for multicast process in a UPnP network;

FIG. 2 illustrates a sequence diagram for an exemplary communication between the UPnP network devices;

FIG. 3 illustrates a flow diagram for the UPnP network device connectivity in accordance with an exemplary embodiment of the present invention;

FIG. 4 illustrates a flow diagram in accordance with an exemplary embodiment of the present invention;

FIG. 5(a) illustrates a UPnP controlled device in accordance with an exemplary embodiment of the present invention;

FIG. 5(b) illustrates a proxy device in accordance with an exemplary embodiment of the present invention;

FIG. 6 illustrates a flow diagram in accordance with an exemplary embodiment of the present invention;

FIG. 7 illustrates a sequence diagram in accordance with an exemplary embodiment of the present invention;

FIG. 8 illustrates a sequence diagram in accordance with an exemplary embodiment of the present invention;

FIG. 9 illustrates a sequence diagram in accordance with an exemplary embodiment of the present invention;

FIG. 10 illustrates a sequence diagram in accordance with an exemplary embodiment of the present invention;

FIG. 11 illustrates a perspective view of an exemplary electronic device which may be utilized in accordance with the various embodiments of the present invention; and

FIG. 12 is a schematic representation of the circuitry which may be included in the electronic device of FIG. 11.

### DETAILED DESCRIPTION OF THE PREFERRED EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

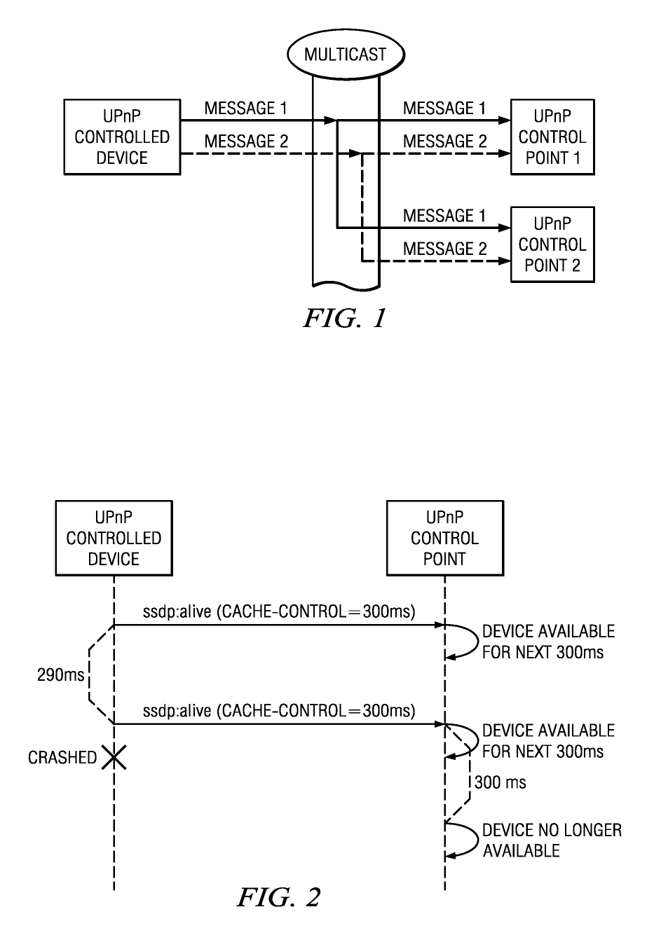

The two interacting entities in a UPnP network are the UPnP ‘controlled device,’ which offers services to control points, and the UPnP ‘control point,’ which uses services offered by the UPnP controlled devices. FIG. 1 illustrates an exemplary diagram, in which a UPnP controlled device multicasts one or more messages, such as Message 1 and Message 2, to one or more UPnP control points, such as UPnP Control Point 1 and UPnP Control Point 2. The UDA defines six steps for enabling UPnP networking among the various devices on the network. The first step is ‘Addressing,’ which enables a UPnP controlled device or control point to acquire an IP address for communicating with the rest of the network. The next step is ‘Discovery,’ which allows UPnP controlled devices to announce their presence to the network, and enables the UPnP control points to discover UPnP controlled devices on the network. The next step, ‘Description,’ occurs when a UPnP control point that has discovered a UPnP controlled device through the Discovery step learns more about the UPnP controlled device by retrieving its description documents. The retrieved documents comprise information regarding the capabilities of the UPnP controlled device, as well as information on how to interact with the controlled device. The next three steps—‘Control,’ ‘Eventing,’ and ‘Presentation’—all occur after the previous three steps, but in no particular order. The Control step allows UPnP control points to issue action requests to one or more UPnP controlled devices, which, in turn, may carry out the requested actions or reject them. In the Eventing step, a UPnP control point may subscribe to the services of the UPnP controlled devices and receive automatic updates regarding state changes in the UPnP controlled device. Finally, through the Presentation step, a UPnP controlled device may expose an HTML-based user interface for controlling and for viewing device status.

The various features of the embodiments of the present invention are better understood by first describing the Discovery and Eventing steps of the UDA in more detail.

Discovery: The discovery step utilizes the Simple Service Discovery Protocol (SSDP). This step is further described with the aid of FIG. 2, in which a UPnP controlled device communicates with a UPnP control point to determine the availability of the UPnP controlled device using the SSDP protocol. When the UPnP controlled device is initially connected to the network, it multicasts a set of ‘ssdp:alive’ messages (sometimes referred to as advertisement or announcement messages) to the network to announce its availability. Through these messages, UPnP control points in the same network become aware of the availability of a UPnP controlled device, and may choose to interact with it. FIG. 2 illustrates one such control point. Each ssdp:alive message contains a CACHE-CONTROL value that specifies the duration of validity of these messages. This duration may, for example, be 300 ms, as illustrated in FIG. 2. In order to remain on the network, the UPnP controlled devices are required to re-send multicast alive messages prior to expiration of the previous set of messages. Accordingly, FIG. 2 illustrates a second ssdp:alive message that is sent by the UPnP Controlled device 290 ms after the first message. Under normal conditions, when a UPnP controlled device is about to leave the network, it multicasts a set of ‘ssdp:byebye’ messages to announce its exit. UPnP control points that receive the ssdp:byebye messages become aware of the departure, and stop interacting with that UPnP controlled device.

In certain situations, however, a UPnP controlled device may not anticipate its departure from the network. For example, a hardware or software crash may cause the UPnP controlled device to leave the network without sending the ssdp:byebye messages. One exemplary situation is illustrated in FIG. 2, where the UPnP controlled device crashes subsequent to sending the second ssdp:alive message. In such cases, the UPnP control points generally rely on the last set of received ssdp:alive messages for determining the availability of the UPnP controlled device. Thus, a UPnP control point may remain unaware of the unavailability of a controlled device until the duration specified in CACHE-CONTROL value has expired. During this time, the UPnP control point may waste valuable resources in maintaining an internal representation of the UPnP controlled device, or in attempting to interact with it in vain. This is further illustrated in FIG. 2, in which the UPnP control point must wait 300 ms after receiving the second ssdp:alive message before it becomes aware of the UPnP controlled device failure.

In addition to the above-described announcement mechanism, the UDA also defines a search mechanism to enable UPnP control points to actively look for UPnP controlled devices on the network. This search mechanism is initiated when a UPnP control point issues a set of multicast or unicast search messages. Upon receiving a search request, a UPnP controlled device that matches the search criteria specified in the search message responds with a message that is similar to the previously-described ssdp:alive message. This mechanism allows a UPnP control point, which has not received earlier ssdp:alive messages (e.g., it has connected to the network right after the previous ssdp:alive messages were sent), to be able to detect the UPnP controlled device without waiting for the next set of ssdp:alive messages, which may not arrive until the time that is specified in the CACHE-CONTROL value has elapsed.

Eventing: In the Eventing step, a UPnP control point subscribes to one or more services of a UPnP controlled device. The subscription allows the UPnP control point to receive updates on changes in the state of the UPnP controlled device. This process is initiated when the UPnP control point sends a subscription message to the UPnP controlled device. Next, the UPnP controlled device responds with a message that indicated whether the subscription has been accepted. If the subscription is accepted, the response message also includes a timeout value that indicates the duration of subscription. A UPnP control point that wishes to receive update messages for longer periods of time must renew its subscription periodically. This may be achieved by sending another subscription message that contains information regarding the current subscription and the next expiration time. Finally, if the UPnP control point wishes to stop receiving update messages, it sends an unsubscription message to the UPnP controlled device. During each of the above described communications, the UPnP controlled device transmits a response message to the UPnP control point indicating the result of the request. If a UPnP control point fails to receive a response message, it may assume the UPnP controlled device is no longer available on the network.

On the UPnP controlled device side, new event messages are communicated to the UPnP control points when the UPnP controlled device state variables change. Such messages are only sent to the UPnP control points that are subscribed to the respective services. A UPnP control point is then required to acknowledge the receipt of such event messages. If a UPnP controlled device fails to receive an acknowledgement, it must abandon the current message but it must actively maintain the current subscription. Furthermore, it must continue sending all future events to the UPnP control point until the subscription time expires. It is thus evident that by maintaining a potentially invalid subscription, the UPnP controlled device may be contributing to network congestion and wasting valuable system resources.

Choosing an appropriate duration for the ssdp:alive messages requires the balancing of several factors. In particular, while it is advantageous to reduce multicast network traffic and minimize processing requirements at both the UPnP controlled devices and the control points, it is also desired to maximize the freshness of UPnP controlled device status. For example, relatively short durations associated with ssdp:alive messages may ensure the availability of up-to-date device status at the expense of additional multicast network traffic. On the other hand, longer durations may compromise freshness of the UPnP controlled device status while significantly reducing multicast network traffic. In an attempt to address this problem, the UDA has recommended using shorter durations for UPnP controlled devices that enter and leave a network frequently, and using longer durations for devices that are expected to stay longer in the network. However, this solution is not suitable for situations where the extent of network connectivity is not known to the UPnP controlled device or the UPnP control point. In addition, the network connection may be severed unexpectedly due to, for example, power failures, system crashes, or user intervention. As such, the UDA recommendation may not be considered a viable solution in many circumstances.

Other solutions have been presented for effecting power savings in a UPnP network. These solutions indirectly reduce multicast traffic by implementing UPnP controlled devices that go completely offline, and only re-attach to the network when requested at a later time, using possibly out-of-band mechanisms. During the offline period, the controlled device is unavailable to regular UPnP control points connected to the network. In order to re-establish contact, an out-of-band wake-up mechanism must be invoked, either by a low-power-aware UPnP control point, or by an intermediate power proxy, to bring the UPnP controlled device back to the network. This technique, not only requires an out-of-band wakeup mechanism, but it also affects the power state of the UPnP controlled device, which may lead to unwanted consequences.

To overcome these and other deficiencies of the systems of prior art, the various embodiments of the present invention provide for methods and devices to minimize network traffic, and to reduce associated processing requirements at UPnP controlled devices and control points, while maximizing freshness of the UPnP controlled device status. These goals are accomplished without disturbing the power state of the UPnP controlled devices, thus maintaining their availability for all UPnP control points on the network. In accordance with the embodiments of the present invention, multicast alive messages that are sent on behalf of a UPnP controlled device may comprise longer expiration times, thereby reducing multicast traffic on the UPnP network, and eliminating the associated processing requirements on the UPnP controlled devices and control points. At the same time, the embodiments of the present invention provide reliable mechanisms to promptly detect and announce any unexpected unavailability of a UPnP controlled device, and to reduce the maximum latency that UPnP control points observe in detecting device unavailability.

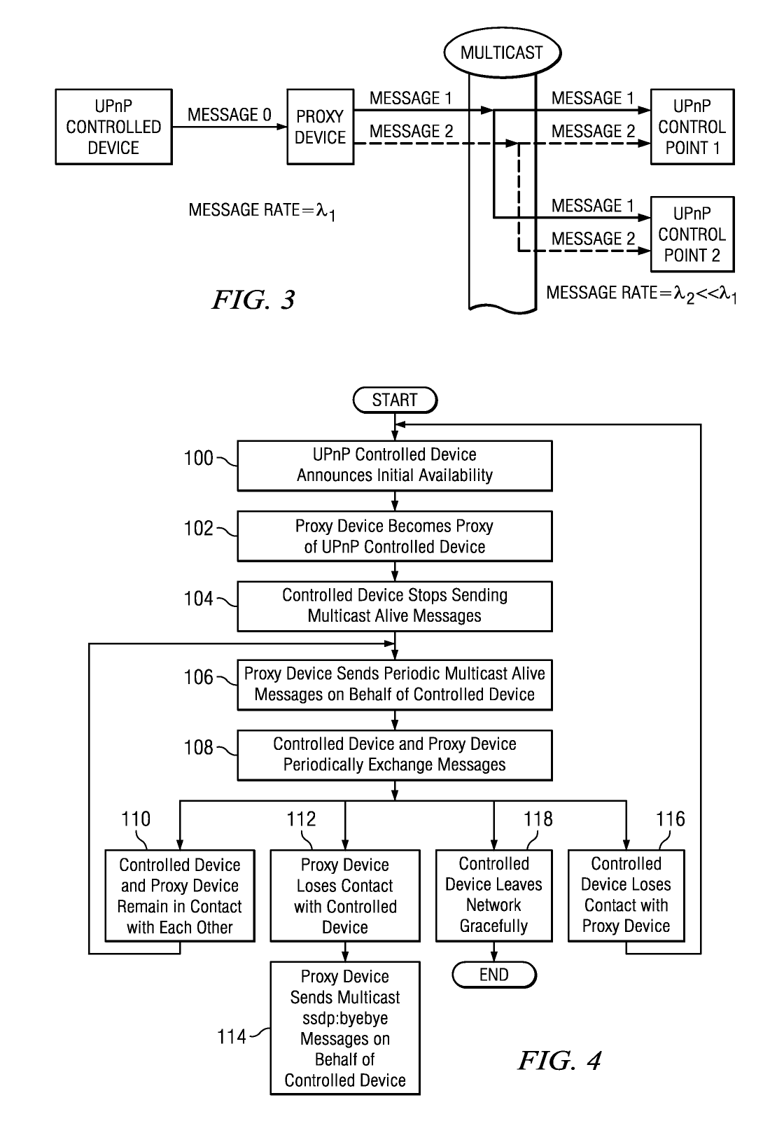

According to an embodiment of the present invention, as illustrated in FIG. 3, an intermediary proxy device is introduced to moderate the multicast discovery messages and to reduce multicast network traffic. In accordance with this embodiment, instead of periodically sending multicast alive messages onto the network to announce its continued availability, a UPnP controlled device may periodically send unicast alive messages to the proxy device to announce its continued availability. On behalf of the UPnP controlled device, the proxy device then periodically sends multicast alive messages—but at a reduced rate—onto the network to inform other network entities regarding the availability of the UPnP controlled device. This is illustrated in FIG. 3, in which a proxy device receives the unicast messages (depicted as Message 0) at a rate λ₁, and transmits one or more multicast messages (depicted as Message 1 and Message 2) to the UPnP control points at a much lower rate, λ₂. Furthermore, if the UPnP controlled device is unexpectedly disconnected from the network, the failure is readily detected when the proxy device fails to receive one or more periodic unicast alive messages. Upon detecting a failure, the proxy device may send multicast ssdp:byebye messages onto the network on behalf of the UPnP controlled device to announce its unavailability. By sending the multicast alive messages at a lower rate than the original UPnP controlled device unicast alive messages, the proxy device, in accordance with the embodiments of the present invention, reduces multicast network traffic while maintaining low latency in detecting the unavailability of a UPnP controlled device.

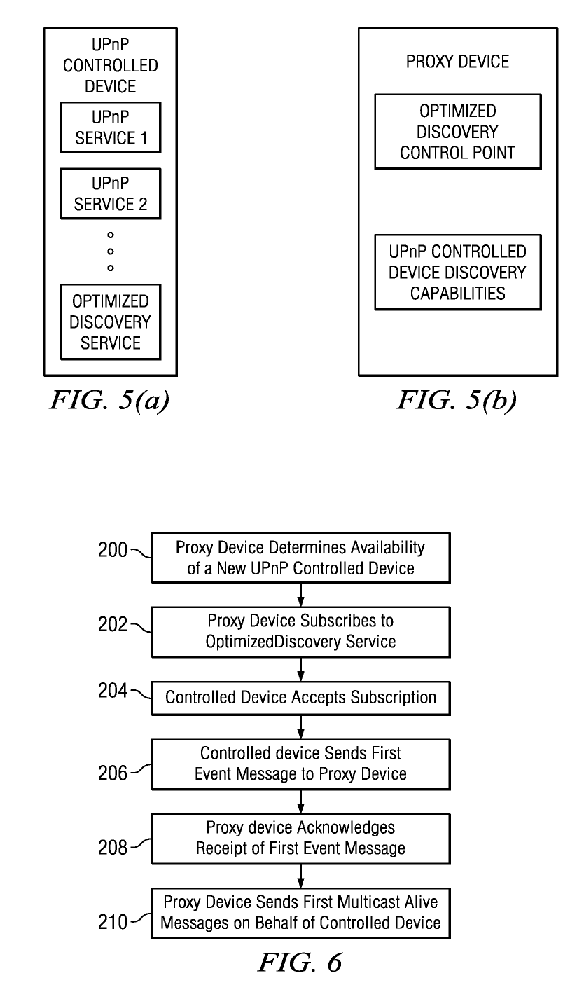

FIG. 4 illustrates a flow diagram in accordance with an exemplary embodiment of the present invention. In describing the various steps of FIG. 4, it is assumed that one or more UPnP controlled devices are utilized in a UPnP network. It is further assumed that a special UPnP service is implemented in the UPnP controlled devices. For example, this special service may be called ‘OptimizedDiscovery’ service. FIG. 5(a) illustrates a diagram of an exemplary UPnP controlled device, in accordance to the embodiments of the present invention, comprising a plurality of UPnP services, including an OptimizedDiscovry service. To further enable the various features of the present invention, it is required to utilize one or more proxy devices that implement a control point of the OptimizedDiscovery service. A proxy device, in addition, implements the Discovery capabilities of a regular UPnP controlled device in accordance with the UDA protocols, i.e., the ability to multicast SSDP messages and to respond to search messages. FIG. 5(b) illustrates a diagram of an exemplary proxy device, in accordance to the embodiments of the present invention, comprising an optimized discovery control point and UPnP controlled device discovery capabilities. Returning to the exemplary flow diagram of FIG. 4, in step 100, the UPnP controlled device announces its initial availability. When a UPnP controlled device is initially connected to the network, it multicasts a set of ssdp:alive messages to announce its availability. This step is identical to the one performed in accordance with the conventional UDA protocols. The multicast messages may comprise information regarding the various services implemented by the UPnP controlled device, including, for example, the special OptimizedDiscovery service.

In Step 102 of FIG. 4, the proxy device becomes the proxy of the UPnP controlled device. This step may comprise other exemplary steps that are illustrated in FIG. 6 and described herein. Upon receiving the multicast messages sent by the UPnP controlled device in Step 100, a proxy device, in step 200 of FIG. 6, determines that a new UPnP controlled device has become available on the network. Next, in step 202, the proxy device subscribes to the OptimizedDiscovery service of that UPnP controlled device. In step 204, the UPnP controlled device accepts the subscription. At this point, the UPnP controlled device also stops accepting future subscriptions to this service. Upon accepting the subscription, the UPnP controlled device, in step 206, sends the first event message to the proxy device according to the Eventing step of the UDA protocol. The first event message comprises at least an event lifetime and an announcement lifetime value. The event lifetime value indicates the duration of time until the next transmission of an event message. The announcement lifetime value indicates the desired lifetime of the multicast alive messages that must be sent by the proxy device. This value is larger (potentially, substantially larger) than the event lifetime value, and is used as the CACHE-CONTROL value for the multicast alive messages that are subsequently sent by the proxy device.

As further illustrated in FIG. 6, upon receiving the first event message, the proxy device, in step 208, acknowledges the receipt of the message according to the conventional UDA protocols. In doing so, the proxy device extracts the event lifetime and announcement lifetime values. Before the initial set of multicast alive messages expire, the proxy device, in step 210, sends the first set of multicast alive messages on behalf of the UPnP controlled device. These messages comprise a CACHE-CONTROL value that indicates the announcement lifetime specified by the UPnP controlled device. These messages further comprise an additional header to indicate that they were sent by a proxy device. For example, this additional header may be referred to as the ‘CAREOF’ header. The CAREOF header may comprise an identifier, such as a Unique Device Name (UDN), to identify the proxy device. The CAREOF header further informs other network entities that a proxy device is already working on behalf of a particular UPnP controlled device, thus eliminating unwanted solicitations by other proxy devices.

Returning now to FIG. 4, after the proxy of a particular UPnP controlled device is determined, the UPnP controlled device stops sending multicast alive messages in step 104. Next, in accordance with step 106, the proxy device sends periodic multicast alive messages on behalf of the UPnP controlled device. While the UPnP controlled device communicates with the proxy at a particular rate, the messages that are multicast by the proxy server are sent at a lower rate. In step 108, the UPnP controlled device and the proxy device periodically exchange messages in accordance with the UDA Eventing protocols. These periodic event messages are similar to the first event message, as previously described in connection with step 206 of FIG. 6, and comprise the event lifetime value. They may also optionally comprise the announcement lifetime value if the UPnP controlled device intends to modify the initial value that was communicated in the first event message. Upon receiving one or more periodic event messages, the proxy device acknowledges their receipt in accordance with the UDA protocols.

As long as the proxy device receives the event message from the UPnP controlled device at expected times, it may continue sending the multicast alive messages on behalf of the UPnP controlled device at the interval specified by the announcement lifetime. This is illustrated in step 110 of FIG. 4, where the flow diagram returns to step 106 if the UPnP controlled device and the proxy device maintain regular contact. If, on the other hand, the proxy device fails to receive one or more event messages from the UPnP controlled device as expected, it may assume that the UPnP controlled device has been disconnected from the network unexpectedly. This is illustrated as step 112 in FIG. 4, in which the proxy device loses contact with the UPnP controlled device. Next, the proxy device may send one or more multicast exit (e.g., ssdp:byebye) messages on behalf of the UPnP controlled device to announce that it is no longer available. This is illustrated in step 114 in FIG. 4. The proxy device may further release any resources that may have been allocated to that UPnP controlled device.

From the UPnP controlled device point of view, a loss of contact with the proxy device may occur if, after sending an event message (whether the initial event message or any subsequent periodic message), it fails to receive an acknowledgement from the proxy device. This loss of contact is shown as step 116 in FIG. 4. Once the UPnP controlled device determines that it has lost contact with the proxy device (or similarly, if it determines that the proxy device is no longer reliable), it may then send its own set of multicast alive messages to the network. This is illustrated in FIG. 4 as the flow diagram returns to step 110 after the controlled device has lost contact with the proxy device in step 116. Since these messages do not contain the CAREOF header, they effectively serve to look for a new proxy device. Until a new proxy device is found, the UPnP controlled device may continue sending periodic multicast alive messages. Once a new proxy device subscribes to the UPnP controlled device, steps 102 to 108 may be repeated in accordance with the above-described embodiments of the present invention.

Note that according to the UDA protocols, a UPnP controlled device is required to continue sending event messages to subscribers that fail to acknowledge the receipt of event messages until the subscription expires. Thus, even when the proxy device of the present invention fails to acknowledge the event messages, the UPnP controlled device continues sending event messages to its proxy device. If the proxy device is still present on the network, it may receive the new set of multicast messages and attempt to subscribe to the UPnP controlled device as a “new” proxy device.

Finally, if during the normal course of network and device operations, the UPnP controlled device decides to leave the network, it may send a set of multicast ssdp:byebye messages to the network. Upon receiving these messages, the proxy device may immediately stop monitoring the UPnP controlled device, and free up any resources allocated in association with the UPnP controlled device. This is illustrated in step 118 of FIG. 4, in which the controlled device leaves the network gracefully.

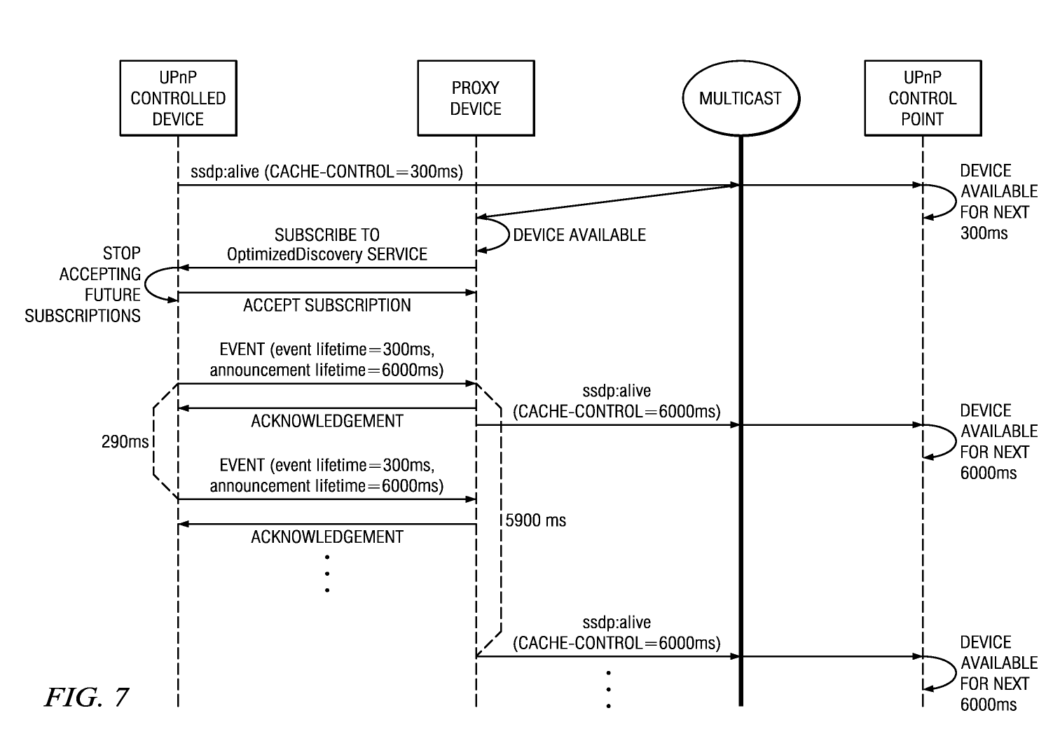

FIGS. 7-10 illustrate the various embodiments of the present invention using exemplary sequence diagrams. In particular, FIG. 7 illustrates the exchange of various messages in accordance with steps 100 to 108 of FIG. 4 of the present invention. The process is initiated once the UPnP controlled device multicasts ssdp:alive messages to the network. An available proxy device then subscribes to the OptimizedDiscovery service of the UPnP controlled device. Next, the UPnP controlled device stops accepting future subscriptions, and informs the proxy device that its subscription has been accepted. The UPnP controlled device subsequently unicasts periodic event messages to the proxy device. These messages are illustrated in FIG. 7 as comprising an event lifetime duration of 300 ms and announcement lifetime duration of 6000 ms. The proxy device, while receiving these unicast messages, periodically sends multicast messages to the various UPnP control points. The multicast messages that are sent by the proxy device of FIG. 7 indicate the availability of the UPnP controlled device for 6000 ms.

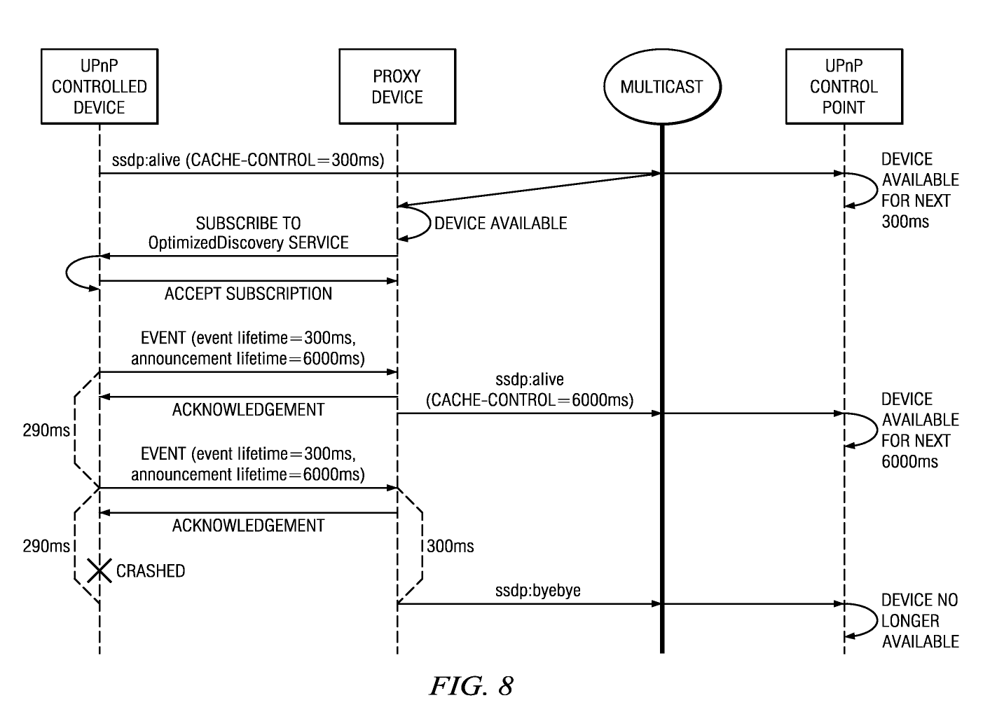

FIG. 8 illustrates the exchange of various messages in accordance with steps 100 to 108, and 112 to 114 of FIG. 4 of the present invention. Similar to the procedure described in connection with FIG. 7, the proxy device becomes the proxy for the UPnP controlled device, and starts multicasting messages on its behalf. In contrast to the scenario in FIG. 7, the UPnP controlled device of FIG. 8 crashes sometime after sending the second unicast alive message to the proxy device. Upon failure to receive the third unicast live message, the proxy device of FIG. 8 determines that the UPnP controlled device is no longer available, and multicasts a ssdp:byebye message on behalf of the UPnP controlled device.

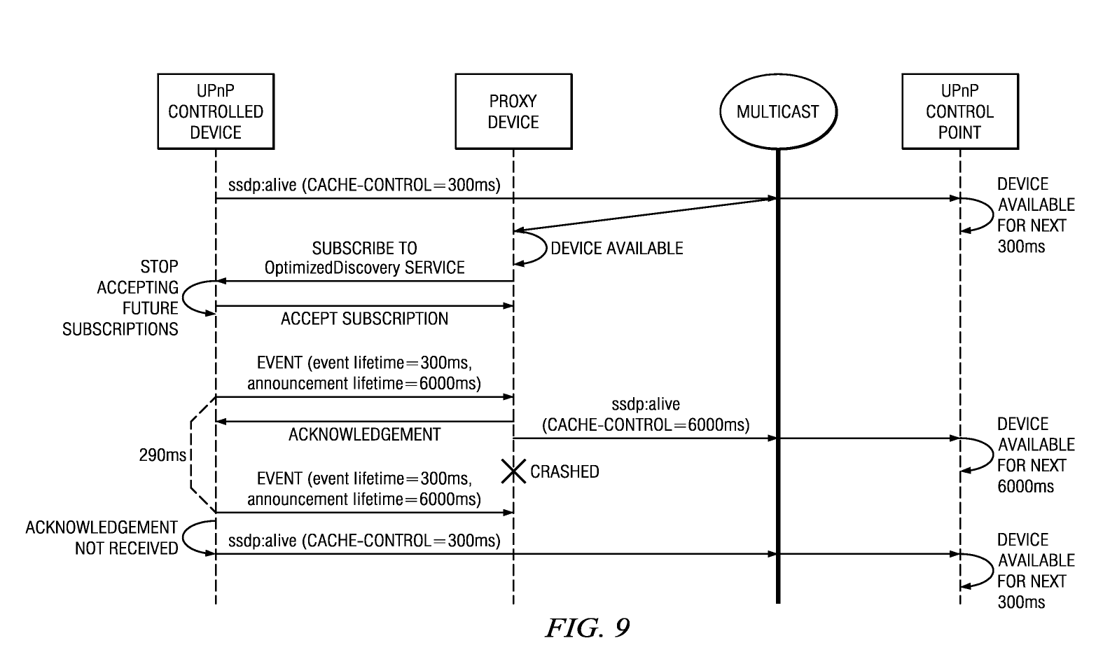

FIG. 9 illustrates the exchange of various messages in accordance with steps 100 to 108 and 116 of FIG. 4 of the present invention. Similar to the procedure described in connection with FIG. 7, the proxy device becomes the proxy for the UPnP controlled device, and starts multicasting messages on its behalf. In contrast to the scenario in FIG. 7, the proxy device of FIG. 9 fails to acknowledge a unicast message that it received from the UPnP controlled device. Upon failure to receive such acknowledgment, the UPnP controlled device of FIG. 9 determines that the proxy device is no longer available, and multicasts an ssdp:alive message. This message, similar to the initial ssdp:alive message sent by the UPnP controlled device, has a CACHE-CONTROL value of 300 ms.

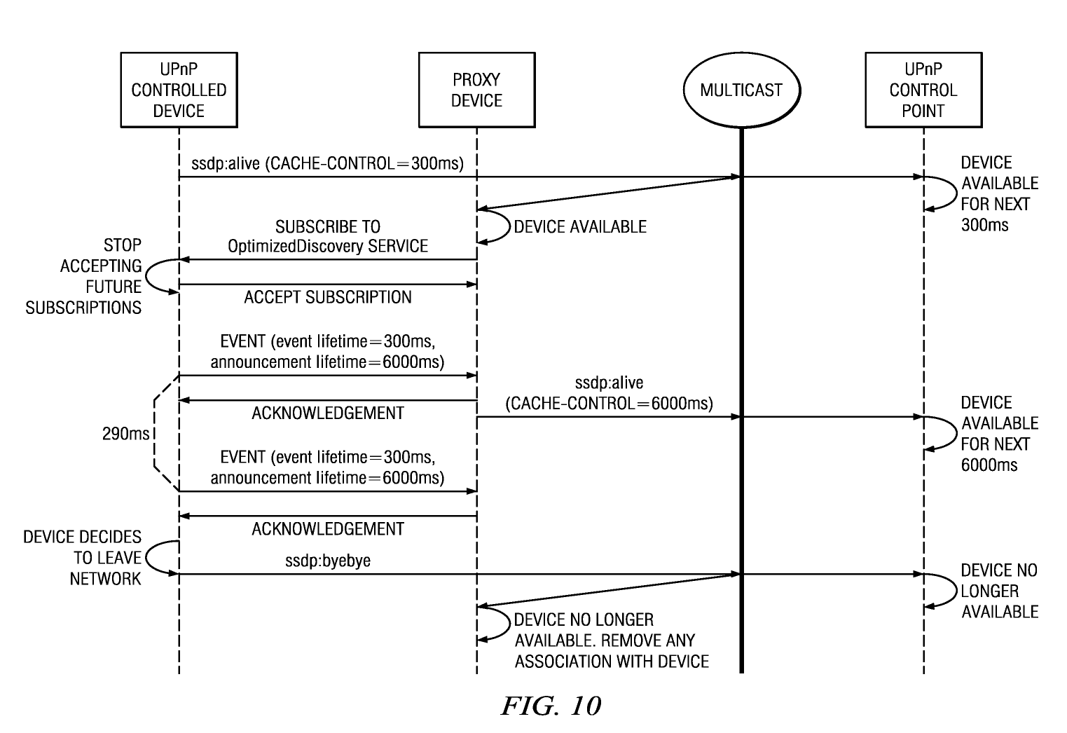

FIG. 10 illustrates the exchange of various messages in accordance with steps 100 to 108, and 118 of FIG. 4 of the present invention. Similar to the procedure described in connection with FIG. 7, the proxy device becomes the proxy for the UPnP controlled device, and starts multicasting messages on its behalf. In contrast to the scenario in FIG. 7, the UPnP controlled device of FIG. 10 decides to leave the network gracefully, and multicasts a ssdp:byebye message. Upon reception of this message, the proxy device releases any resources that were allocated in association with the UPnP controlled device.

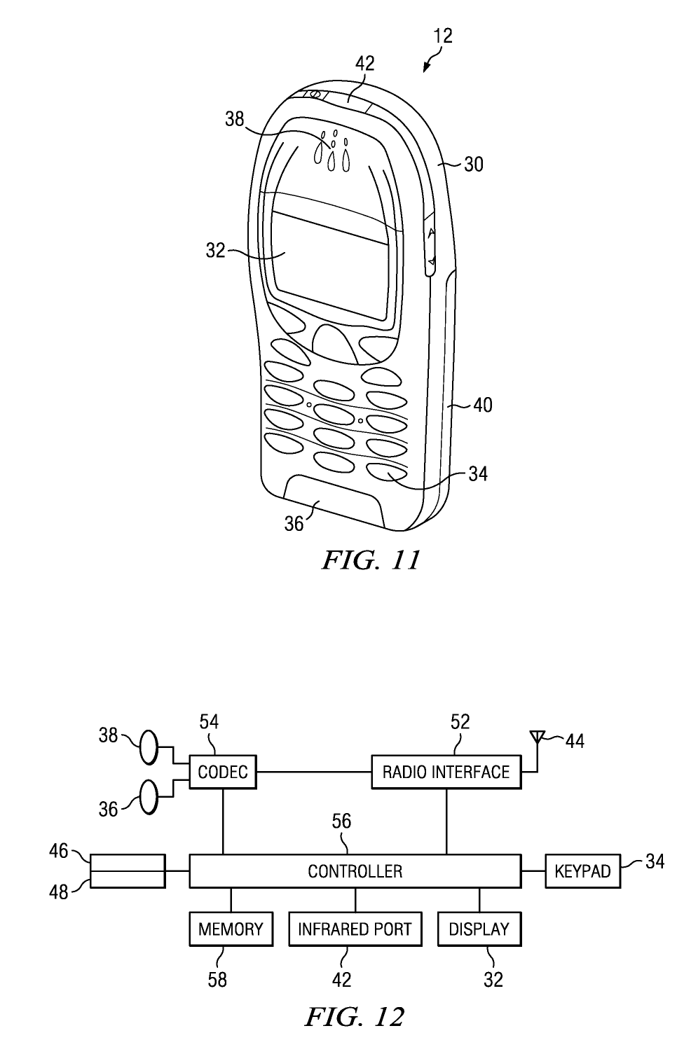

FIGS. 11 and 12 show one representative electronic device 12 which may be implemented in a UPnP network architecture. For example, the electronic device 12 of FIGS. 11 and 12 may comprise one or more of the UPnP controlled device, the UPnP control point, the proxy device, or a combination thereof. It should be understood, however, that the present invention is not intended to be limited to one particular type of device. The electronic device 12 of FIGS. 11 and 12 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. The above described components enable the electronic device 12 to send/receive various messages to/from other devices that may be reside on a network in accordance with the various embodiments of the present invention. Individual circuits and elements are all of a type well known in the art, for example in the Nokia range of mobile telephones.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method comprising:
receiving one or more unicast messages from a controlled device at a proxy device; and
transmitting one or more multicast messages from said proxy device, in response to said one or more unicast messages, over the network, wherein said multicast messages are transmitted at a lower rate than said unicast messages.

2. The method of claim 1, wherein said multicast messages comprise at least one of the following: expiration times that are larger than expiration times associated with said unicast messages, information associated with said controlled device, or information associated with said proxy device.

3. The method of claim 1, wherein said unicast messages comprises at least one of an event lifetime and an announcement lifetime value.

4. The method of claim 1, wherein said multicast messages are transmitted in response to receiving one or more unicast messages at predefined intervals.

5. The method of claim 4, wherein said proxy device transmits one or more multicast exit messages upon failure to receive said unicast messages.

6. The method of claim 1, wherein said controlled device multicasts one or more exit messages.

7. The method of claim 6, wherein said proxy device releases allocated resources associated with said controlled device in response to said exit messages.

8. The method of claim 1, wherein said proxy device transmits an acknowledgment message in response to each of said unicast messages.

9. The method of claim 8, wherein said controlled device transmits one or more multicast alive messages upon failure to receive an acknowledgement message.

10. The method of claim 1, wherein said proxy device comprises a control point on said network.

11. The method of claim 1, wherein said controlled device implements an OptimizedDiscovery service.

12. The method of claim 11, wherein said proxy device subscribes to said OptimizedDiscovery service.

13. An apparatus, comprising:
a receiver configured to receive one or more unicast messages from a controlled device at a proxy device; and
a transmitter configured to transmit one or more multicast messages from said proxy device over the network, wherein said multicast messages are transmitted at a lower rate than said unicast messages.

14. The apparatus of claim 13, wherein said multicast messages comprise at least one of the following: expiration times that are larger than expiration times associated with said unicast messages, information associated with said control device, or information associated with said proxy device.

15. The apparatus of claim 13, wherein said unicast messages comprises at least one of an event lifetime and an announcement lifetime value.

16. The apparatus of claim 13, wherein said multicast messages are transmitted in response to receiving one or more unicast messages at predefined intervals.

17. The apparatus of claim 16, wherein said proxy device transmits one or more multicast exit messages upon failure to receive said unicast messages.

18. A computer program product, embodied on a computer-readable medium, comprising computer code configured to perform the processes of claim 1.

19. An apparatus, comprising:
a processor; and
a memory unit communicatively connected to the processor, the memory unit embodying computer code configured to perform processes of claim 1.

20. A apparatus configured to implement a special delivery service, comprising
a transmitter configured to transmit one or more multicast messages from a controlled device; and
a receiver configured to receive one or more messages from a proxy device, wherein said transmitter is further configured to transmit one or more unicast message to said proxy device in accordance with a special delivery service of said controlled device.
